(19) United States
(12) Patent Application Publication
(10) Pub. No.: US 2011/0235067 A1
(43) Pub. Date: Sep. 29, 2011

(54) Method and system for generating nametags

(76) Inventors: Brian Michael Dodo, Amherstview (CA); Jennifer Lynne Cameron, Amherstview (CA)

(21) Appl. No.: 13/065,085

(22) Filed: Mar. 14, 2011

Related U.S. Application Data
(60) Provisional application No. 61/282,728, filed on Mar. 24, 2010.

(51) Int. Cl. G06K 15/02

(52) U.S. Cl. 358/1.6; 358/1.18

(57) ABSTRACT

A method for generating a nametag is provided. A database having stored therein data associated with a wearer of the nametag and a computer connected to the database is provided. Further, data indicative of a predetermined nametag template are provided. Using a processor of the computer the data indicative of the predetermined nametag template are received. Using the processor of the computer data indicative of the wearer of the nametag are received. The processor of the computer then retrieves the data associated with the wearer of the nametag from the database in dependence upon the data indicative of the wearer of the nametag and inserts the same into the predetermined nametag template. The processor of the computer then generates nametag printing data in dependence upon the predetermined nametag template and the inserted data. Using a printer connected to the computer the nametag printing data are printed.

### FIELD OF THE INVENTION

The present invention relates to nametags or badges and in particular to a method and system for generating nametags.

### BACKGROUND OF THE INVENTION

Larger meetings such as, for example, conferences and trade shows generally have many people attending, most of them strangers to one another. Therefore, event planners and organizers provide nametags or badges to attendees of meetings and conferences. Typically, the nametags have the name of an attendee and his or her company affiliation as well as the meeting or convention title printed thereon. There are several nametag options available on the market such as, for example, self-adhesive stickers, plastic pockets with lanyard or metal clip.

Typically, each attendee of a conference is provided with event specific information such as, for example, an event agenda, speaker bios, and a floor plan which is provided as booklet. Additionally, a notebook is provided for the attendee to record information during the conference.

However, carrying various items is often times difficult at conferences since attendees are required to frequently change locations—for example, sessions take place in different rooms, networking takes place between sessions in hallways or designated areas; and meals are served in dining areas or restaurants.

State of the art nametags such as, for example, self adhesive stickers require provision of the additional information for the attendee in a separate information package, or the name tag is formed as a plastic pocket or folder having additional information sheets disposed therein. However, access to the information sheets disposed in the plastic pockets or folders is cumbersome and requires removal of the nametag.

Generating nametags and conference information is a time consuming process for event organizers and requires planning well ahead of an event for printing and assembling the nametags. However, the deadline for attendee registration of a conference is typically very close to the conference, substantially limiting the time for printing and assembling the nametags.

It is desirable to provide a method and system for generating nametags on-site of a conference or tradeshow.

It is also desirable to provide a method and system for generating nametags on-site of a conference or tradeshow using data related to an attendee that has been previously stored in a database.

It is also desirable to provide a method and system for generating nametags on-site that provide easy access to additional information.

### SUMMARY OF THE INVENTION

Accordingly, one object of the present invention is to provide a method and system for generating nametags on-site of a conference or tradeshow.

Another object of the present invention is to provide a method and system for generating nametags on-site of a conference or tradeshow using data related to an attendee that has been previously stored in a database.

Another object of the present invention is to provide a method and system for generating nametags on-site that provide easy access to additional information.

According to one aspect of the present invention, there is provided a method for generating a nametag. A database having stored therein data associated with a wearer of the nametag and a computer connected to the database is provided. Further, data indicative of a predetermined nametag template are provided. Using a processor of the computer the data indicative of the predetermined nametag template are received. Using the processor of the computer data indicative of the wearer of the nametag are received. The processor of the computer then retrieves the data associated with the wearer of the nametag from the database in dependence upon the data indicative of the wearer of the nametag and inserts the same into the predetermined nametag template. The processor of the computer then generates nametag printing data in dependence upon the predetermined nametag template and the inserted data. Using a printer connected to the computer the nametag printing data are printed.

According to another aspect of the present invention, there is further provided a client computer connected to the computer via a computer network. Using a processor of the client computer user input data are received and provided to the computer. Using the processor of the computer the data indicative of the wearer of the nametag and the data associated with the wearer of the nametag in dependence upon the user input data are generated and stored in the database.

According to another aspect of the present invention, there is further provided a storage medium having stored therein executable commands for execution on a processor. The processor when executing the commands receives data indicative of a predetermined nametag template and data indicative of a wearer of a nametag. The processor then retrieves data associated with the wearer of the nametag from a database connected to the processor in dependence upon the data indicative of the wearer of the nametag and inserts the data indicative of the wearer of the nametag and the data associated with the wearer of the nametag into the predetermined nametag template. The processor then generates nametag printing data in dependence upon the predetermined nametag template and the inserted data.

The advantage of the present invention is that it provides a method and system for generating nametags on-site of a conference or tradeshow.

A further advantage of the present invention is that it provides a method and system for generating nametags on-site of a conference or tradeshow using data related to an attendee that has been previously stored in a database.

A further advantage of the present invention is that it provides a method and system for generating nametags on-site that provide easy access to additional information.

### BRIEF DESCRIPTION OF THE DRAWINGS

A preferred embodiment of the present invention is described below with reference to the accompanying drawings, in which:

FIGS. 1a to 1c are simplified block diagrams illustrating a preferred nametag;

FIG. 2 is a simplified block diagram illustrating a system for implementing a method for generating a nametag according to a preferred embodiment of the invention; and,

FIGS. 3 and 4 are simplified flow diagrams illustrating the method for generating a nametag according to a preferred embodiment of the invention.

### DESCRIPTION OF THE PREFERRED EMBODIMENT

Unless defined otherwise, all technical and scientific terms used herein have the same meaning as commonly understood by one of ordinary skill in the art to which the invention belongs.

Although any methods and materials similar or equivalent to those described herein can be used in the practice or testing of the present invention, the preferred methods and materials are now described.

While the description of the preferred embodiments herein below is with reference to the generation of nametags for use at a conference, it will become evident to those skilled in the art that the embodiments of the invention are not limited thereto, but are also employable for generating nametags for various applications such as, for example, trade shows, organizations (museums, hospitals, factories) and guided tours (shows, travel, concerts).

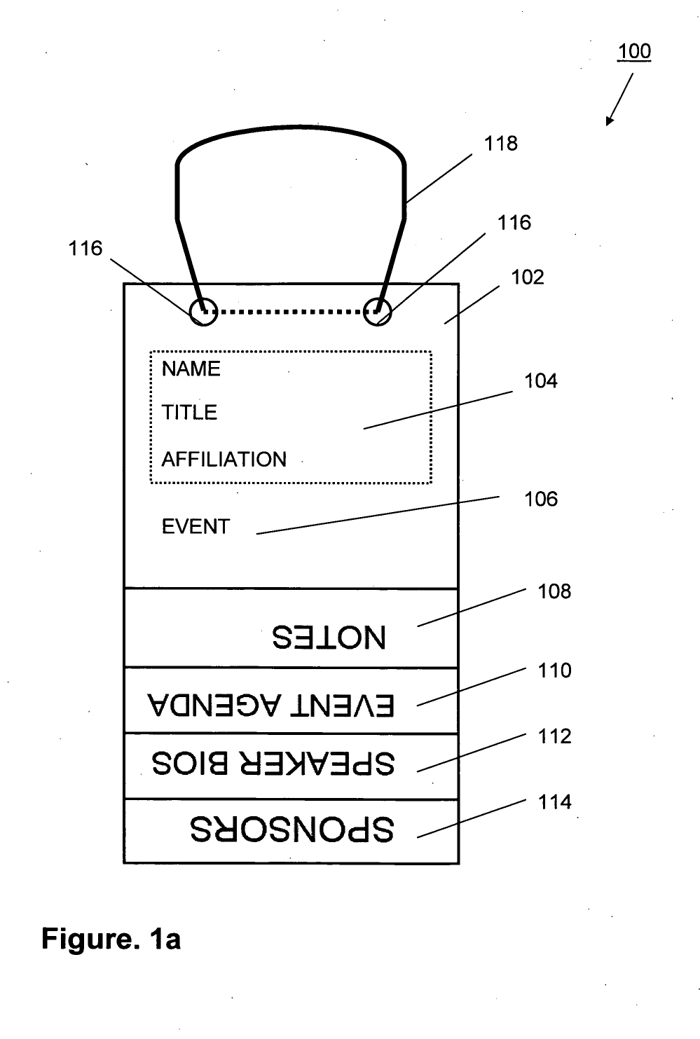

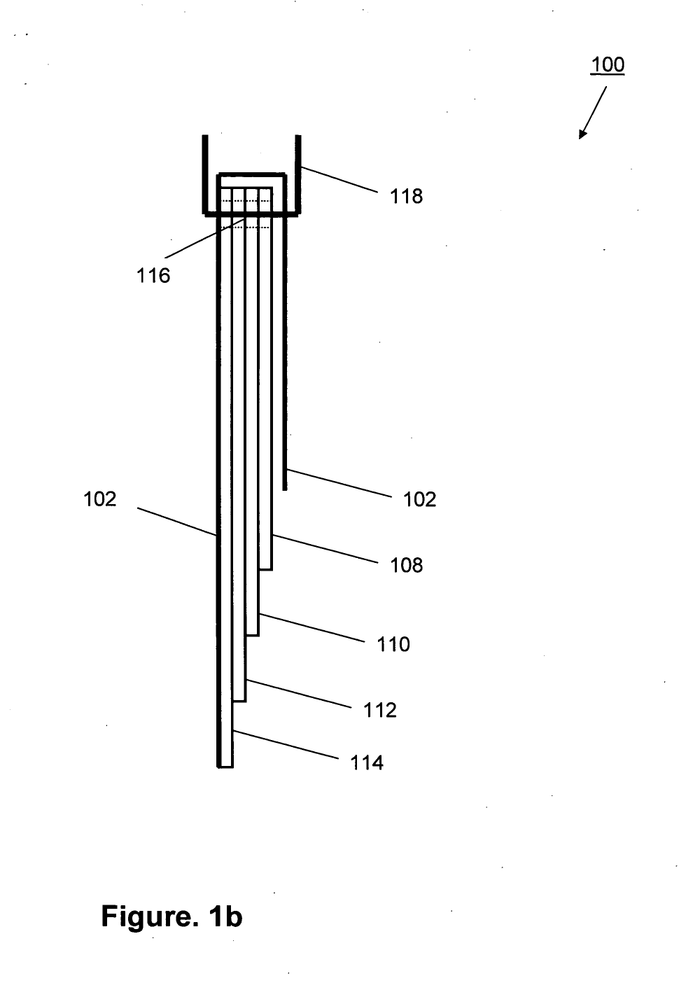

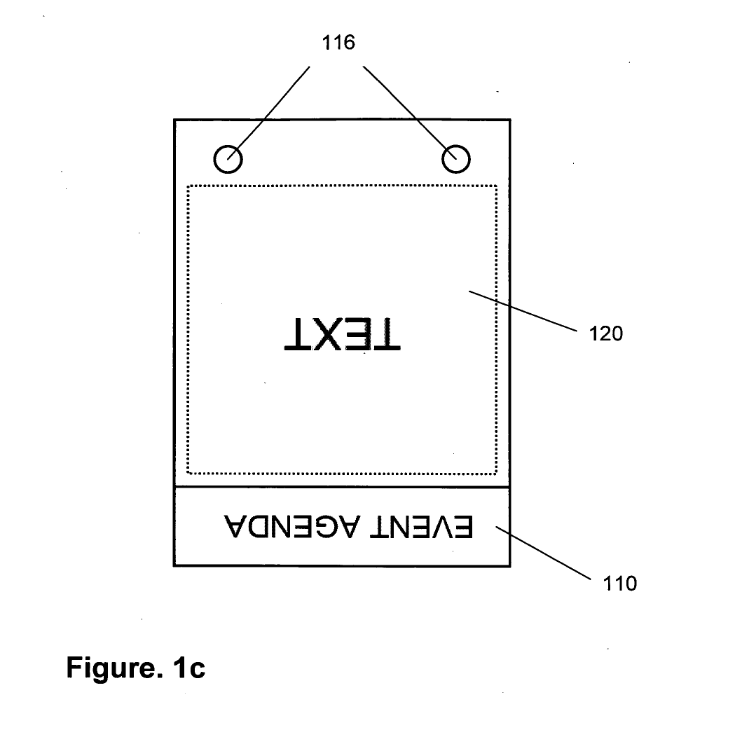

The method and system for generating a nametag according to a preferred embodiment of the invention will be described herein below with reference to the preferred nametag 100, as illustrated in FIGS. 1a to 1c, but is not limited thereto. The nametag 100 comprises a cover sheet 102 having on a front surface thereof printed information 104 of an attendee such as name, title, and affiliation as well as the name of the event 106. Of course, there are numerous other possibilities for printing the cover sheet such as different information and/or appealing graphics for display. The text on the front of the cover sheet 102 is printed right-side-up for display to others, i.e. a person standing in front of the attendee is able to read the information 104 and 106.

Disposed below the cover sheet 102 are a plurality of sheets organized in a plurality of sections 108, 110, 112, and 114, as illustrated in FIGS. 1a and 1b, for providing conference information.

The top sheet of each section has printed on a bottom portion thereof an indicator of the contents of the respective section such as: NOTES; EVENT AGENDA; SPEAKER BIOS; and SPONSORS, as illustrated in FIG. 1a. The remaining portion of the top sheet as well as the following sheets have text 120 printed thereupon or are left blank to enable the attendee to take notes. The information printed on these sheets is printed upside down to allow the attendee to view the information without removing the nametag 100, as illustrated in FIGS. 1a and 1c. Preferably, the nametag 100 comprises staggered tabs to enable easy access to the information, by providing the sheets of different sections with different lengths, as illustrated in FIG. 1b. Alternatively, the top sheet of each of the different sections is provided with a side tab.

Preferably, the sheets comprise apertures 116 disposed in a top portion thereof for accommodating there through a string 118 for holding the sheets together and for forming a lanyard for hanging the nametag 100 around the neck of the attendee. Optionally, the sheets of the sections 108, 110, 112, and 114 are glued together at the top edge forming a spine. The top sheet 102 is formed as a single sheet just covering the front or, alternatively, folded to form a front and a back cover, as illustrated in FIG. 1b.

Alternatively, the sheets are assembled using, for example, stitching, soldering, or stapling depending on the sheet material employed.

Preferably, the sheets are made of recyclable material such as recyclable paper. Alternatively, other materials such as, for example, plastic, cotton, metal or combinations thereof are employed depending on the application and desired customer appeal.

Preferably, the nametag 100 is made of paper and biodegradable string material to reduce the environmental impact.

The nametag 100 is easy to carry; enables easy access to information without removing the nametag; is easy to assemble; allows use of readily available recyclable materials; and does not require custom lanyards.

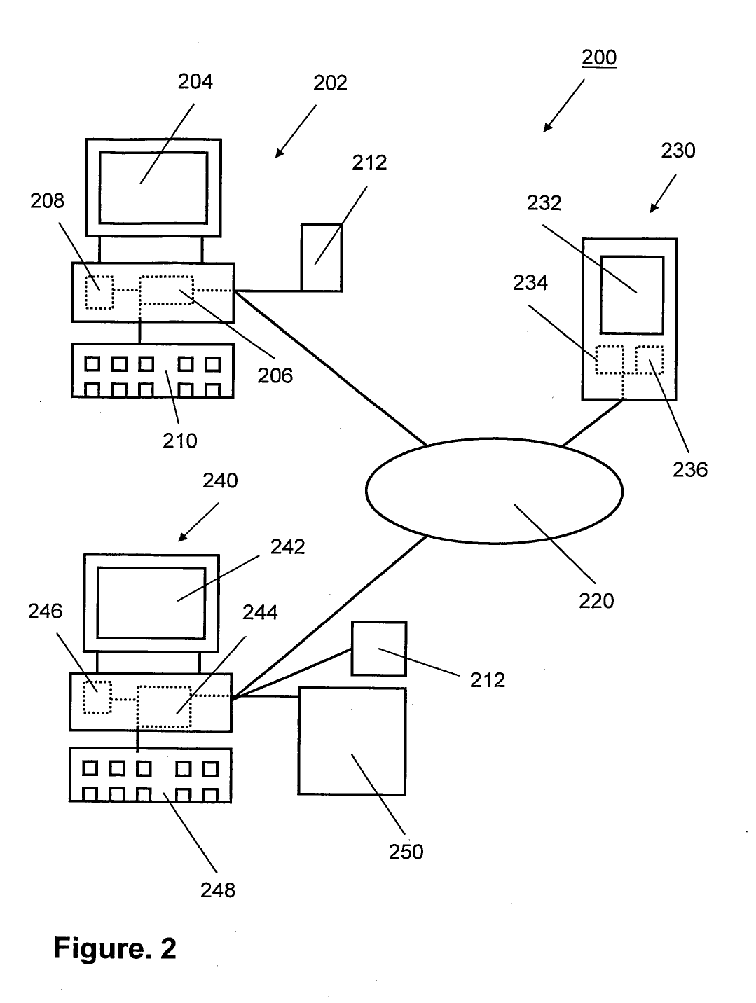

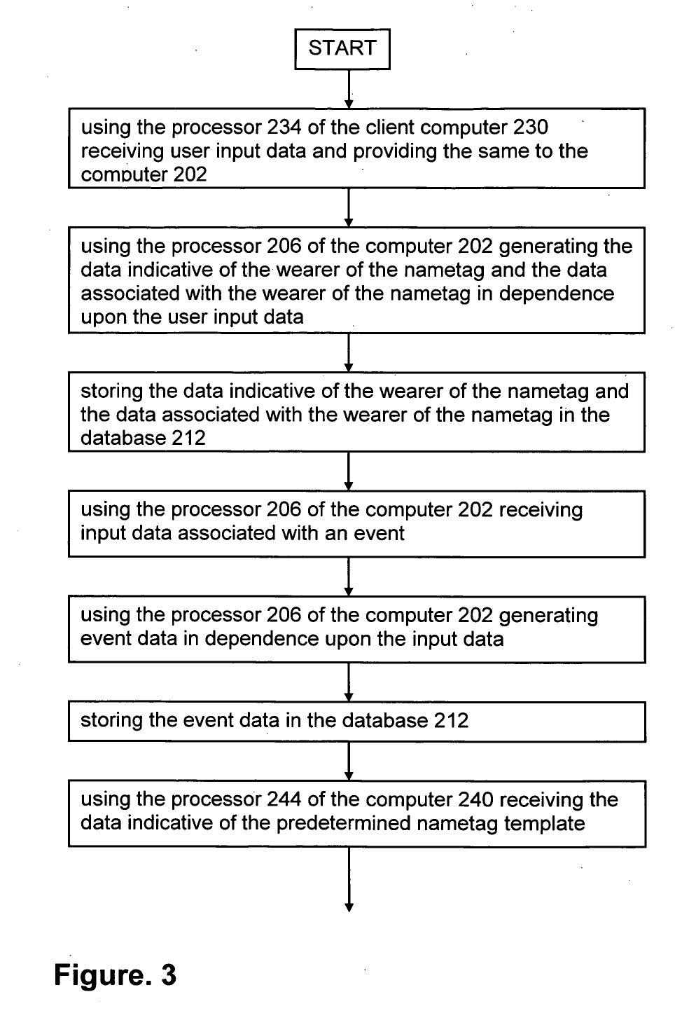

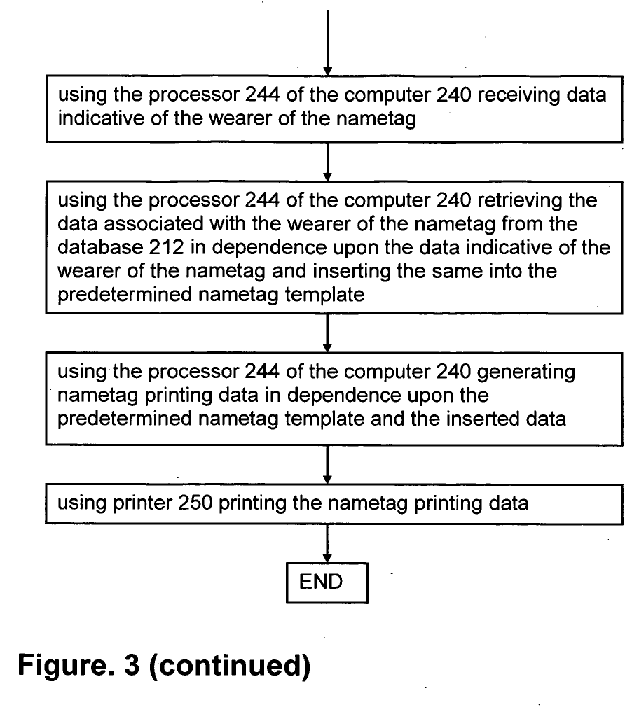

Referring to FIGS. 2 to 4, a method and computer system 200 for generating a nametag according to a preferred embodiment of the invention is provided. The computer system 200 comprises a computer 202 such as, for example, a workstation, Personal Computer or Laptop computer operated by a conference organizer. The computer 202 is connected to a computer network 220 such as, for example, the Internet, enabling an attendee of the conference to register online using his or her client computer 230 such as, for example, a Personal Computer or handheld wireless device. Executing executable commands stored in memory 236, processor 234 receives information from the attendee such as, for example, name, title, and affiliation via user interface 232 and provides the same—10—to the processor 206 of the computer 202. Executing executable commands stored in memory 208, processor 206 of the computer 202 generates—12—data indicative of the wearer of the nametag—such as, for example, the wearer's name—and data associated with the wearer of the nametag—such as, for example, title and affiliation—in dependence upon the user input data. The data indicative of the wearer of the nametag and the data associated with the wearer of the nametag are then stored in database 212 connected to the computer 202. The database 212 is, for example, a designated database connected to the computer 202 via a Local Area Network (LAN), an external hard drive, a USB key or an internal hard drive of the computer 202. The database 212 is, for example, a relational database or an object oriented database and is implemented using standard technology such as, for example, MySQL or PostgresSQL.

Using user interface 204 and 210 of the computer 202 the organizer provides—16-input data associated with the conference—such as, for example, name of the conference, agenda, and speaker bios—to the processor 206 which generates—18—event data in dependence upon the input data and stores—20—the same in the database 212.

Typically, the steps 10 to 20 are performed at a location of the conference organizer—such as a university department—which is different from the location where the conference takes place—such as a conference center. Additional to the steps 10 to 20 the organizer is provided with data indicative of a predetermined nametag template which the organizer, for example, stores in the database 212. Preferably, the data indicative of the predetermined nametag template are generated by a graphic designer in order to provide a pleasing design and dimensions fitting the size of the nametag. The organizer is enabled to enter and or modify text. Preferably, the data indicative of the predetermined nametag template are provided as Portable Document Format (PDF) file generated using standard software such as, for example, Adobe Acrobat, Ghostscript, Foxit, Nitro PDF. Optionally, other formats such as, for example, postscript are employed using software such as Envoy.

At the conference the organizer connects computer 240 to the database 212. Optionally, the computer 240 and the computer 202 are the same computer. The computer 240 is, for example, directly connected to the database 212 using an external hard drive, a USB key, or an external memory card such as SD Memory card. Alternatively, the computer 240 is connected to the database 212 via the computer network 220.

At 22—using the processor 244 of the computer 240 the data indicative of the predetermined nametag template are received, for example, from the database 212. Using the processor 244 of the computer 240 data indicative of the wearer of the nametag are received—24. For example, upon arrival an attendee of the conference enters his or her name using user interface 242 and 248 of the computer 240. Executing executable commands stored in memory 246 the processor 244 then retrieves—26—the data associated with the wearer of the nametag from the database 212 in dependence upon the data indicative of the wearer of the nametag—the name entered by the attendee—and inserts the same into respective fields of the predetermined nametag template. For example, the data indicative of the title of the wearer are retrieved and inserted into the respective field for displaying the wearer's title of the nametag template. Optionally, a portion of the event data associated with the wearer of the nametag—such as, for example, data indicative of the wearer being a speaker or panelist—are retrieved from the database and inserted into respective fields of the nametag template. If no event data associated with the wearer of the nametag are to be inserted, the field is, for example, left blank, removed, or filled with background.

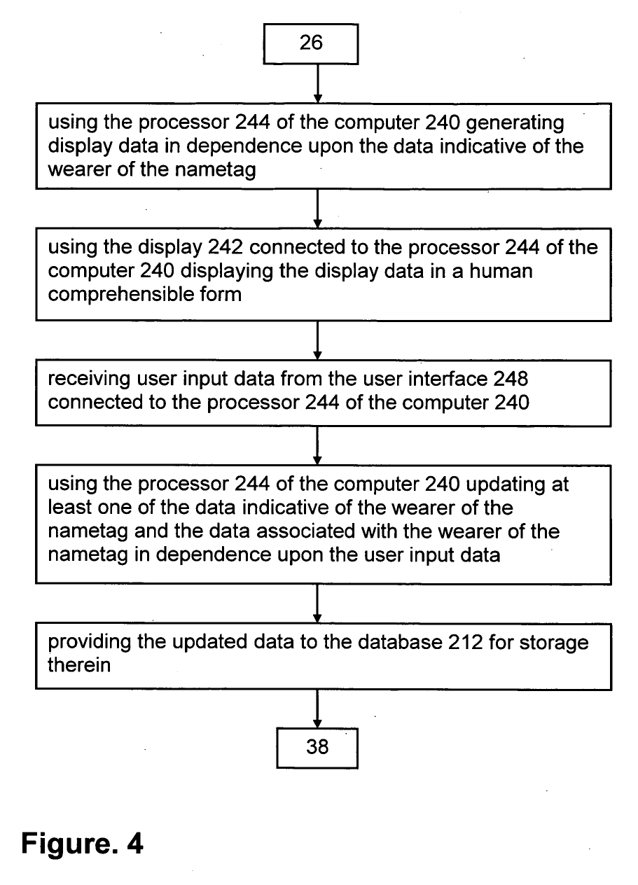

Referring to FIG. 4, the attendee is enabled to correct the data indicative of the wearer of the nametag and the data associated with the wearer of the nametag. For example, when registering online the attendee has misspelled his or her name. Using the processor 244 of the computer 240 display data are generated in dependence upon the data indicative of the wearer of the nametag—28 and displayed in a human comprehensible form—30—using the display 242 connected to the processor 244 of the computer 240. The attendee then corrects the displayed information using the user interface 248. Upon receipt—32—of the user input data the processor 244 updates—34—at least one of the data indicative of the wearer of the nametag and the data associated with the wearer of the nametag in dependence upon the user input data and provides—36—the updated data to the database 212 for storage therein.

The processor 244 of the computer 240 then generates—38—nametag printing data in dependence upon the predetermined nametag template and the inserted data and provides the same to printer 250 for printing—40.

Optionally, the nametag template and the attendee information are displayed on graphical display 242 illustrating, for example, a layout of the top sheet 102 of the nametag 100 with the information. After provision and display of the information the same is printed on the top sheet 102 using printer 250.

Preferably, the sheets of the nametag are pre-cut to appropriate size and pre-printed having printed some appealing graphics or images and the event data thereupon, leaving only the data indicative of the wearer of the nametag and the data associated with the wearer of the nametag to be printed into respective fields of the top sheet 102, substantially reducing printing time on-site.

For example, a plurality of sheets having information printed thereupon corresponding to sections 108, 110, 112, and 114, is provided. The sheets are glued or stapled together at the top portion and comprise apertures 11.6. The top sheet 102 is also provided and has the event information printed thereupon and comprises apertures 116. Using the printer 250 the information is printed onto the top sheet 102. After printing of the information the nametag is assembled by folding the top sheet 102, covering the front and the back of the plurality of sheets and disposing a string through the apertures 116 which is then tied to form a loop of predetermined size.

Alternatively, all data are printed on-site enabling the organizer to include last minute changes—for example, change or cancellation of a session. For example, the processor 244 is used to update the event data and to insert the updated event data into the predetermined nametag template.

The method for generating a nametag is implemented using standard programming techniques and programming languages such as, for example, JavaScript programs, Objective C, and C#. Communication via the computer network 220 is enabled using standard communication technologies such as, for example, Hyper Text Transfer Protocol (HTTP), Virtual Private Networks (VPN), and Secure Socket Layers (SSL).

The present invention has been described herein with regard to preferred embodiments. However, it will be obvious to persons skilled in the art that a number of variations and modifications can be made without departing from the scope of the invention as described herein.

What is claimed is:

1. A method for generating a nametag comprising:
providing a database having stored therein data associated with a wearer of the nametag;
providing a computer connected to the database;
providing data indicative of a predetermined nametag template;
using a processor of the computer receiving the data indicative of the predetermined nametag template;
using the processor of the computer receiving data indicative of the wearer of the nametag;
using the processor of the computer retrieving the data associated with the wearer of the nametag from the database in dependence upon the data indicative of the wearer of the nametag and inserting the same into the predetermined nametag template;
using the processor of the computer generating nametag printing data in dependence upon the predetermined nametag template and the inserted data; and,
printing the nametag printing data.

2. A method as defined in claim 1 comprising:
using the processor of the computer generating display data in dependence upon the data indicative of the wearer of the nametag; and,
using a display connected to the processor of the computer displaying the display data in a human comprehensible form.

3. A method as defined in claim 2 comprising:
receiving user input data from a user interface connected to the processor of the computer; and,
using the processor of the computer updating at least one of the data indicative of the wearer of the nametag and the data associated with the wearer of the nametag.

4. A method as defined in claim 3 comprising providing the updated data to the database for storage therein.

5. A method as defined in claim 1 comprising:
providing a client computer connected to the computer via a computer network;
using a processor of the client computer receiving user input data and providing the same to the computer;
using the processor of the computer generating the data indicative of the wearer of the nametag and the data associated with the wearer of the nametag in dependence upon the user input data; and,
storing the data indicative of the wearer of the nametag and the data associated with the wearer of the nametag in the database.

6. A method as defined in claim 1 comprising:
receiving input data associated with an event;
generating event data in dependence upon the input data; and,
storing the event data in the database.

7. A method as defined in claim 6 comprising using the processor of the computer inserting at least a portion of the event data into the predetermined nametag template.

8. A method as defined in claim 7 wherein the at least a portion of the event data is associated with the wearer of the nametag.

9. A method as defined in claim 6 wherein the predetermined nametag template is indicative of a plurality of sheets forming the nametag and wherein the data indicative of the wearer of the nametag and the data associated with the wearer of the nametag are inserted into the predetermined nametag template for being printed onto a top sheet of the nametag and the event data are inserted into the predetermined nametag template for being printed onto at least a sheet following the top sheet of the nametag.

9. A method as defined in claim 6 comprising:
using the processor of the computer updating the event data: and,
using the processor of the computer inserting the updated event data into the predetermined nametag template.

10. A storage medium having stored therein executable commands for execution on a processor,
the processor when executing the commands performing:
receiving data indicative of a predetermined nametag template;
receiving data indicative of a wearer of a nametag;
retrieving data associated with the wearer of the nametag from a database connected to the processor in dependence upon the data indicative of the wearer of the nametag; inserting the data indicative of the wearer of the nametag and the data associated with the wearer of the nametag into the predetermined nametag template; and,
generating nametag printing data in dependence upon the predetermined nametag template and the inserted data.
